(19) United States
(12) Patent Application Publication
(10) Pub. No.: US 2026/0072873 A1
(43) Pub. Date: Mar. 12, 2026

(54) DATA PROCESSING METHOD, ELECTRONIC DEVICE, AND MEDIUM

(71) Applicant: BEIJING BAIDU NETCOM SCIENCE TECHNOLOGY CO., LTD., Beijing (CN)

(72) Inventor: Xinxing WANG, Beijing (CN)

(21) Appl. No.: 19/395,234

(22) Filed: Nov. 20, 2025

(30) Foreign Application Priority Data
Jun. 13, 2025 (CN) 202510796788.X

(51) Int. Cl. G06F 16/13

(52) U.S. Cl. CPC G06F 16/13

(57) ABSTRACT

A data processing method, an electronic device, and a medium are provided. The method includes: in response to receiving a data reading request, determining a first storage file and a second storage file according to an identifier of data to be read in the request, where a storage mode of the first storage file is different from that of the second storage file, and a data length of the second storage file is greater than that of the first storage file; determining an index result according to a position information of the data to be read and first index information of the first storage file; reading first sub-data from the first storage file when the index result indicates that the first storage file includes the first sub-data; and reading second sub-data from the second storage file according to the position information and index information of the second storage file.

### CROSS-REFERENCE TO RELATED APPLICATION(S)

This application claims the benefit of Chinese Patent Application No. 202510796788.X filed on Jun. 13, 2025, the whole disclosure of which is incorporated herein by reference.

### TECHNICAL FIELD

The present disclosure relates to the field of data processing technologies, particularly to the fields of data reading and data storage technologies, and more specifically, to a data processing method, an electronic device, and a medium.

### BACKGROUND

In a block storage scenario, a user modification to a file is regarded as a new write operation, and the modification of the file is implemented by gradually writing the modified data into a block storage system.

However, block storage often involves a large number of random modifications, and the above modification manner may cause the modified data to be stored in a multi-layer structure, which affects data storage efficiency and reading efficiency.

### SUMMARY

The present disclosure provides a data processing method, an electronic device, and a medium.

According to an aspect of the present disclosure, a data processing method is provided, including: in response to receiving a data reading request, determining a first storage file and a second storage file according to an identifier of data to be read in the data reading request, where a storage mode of the first storage file is different from that of the second storage file, and a data length of the second storage file is greater than that of the first storage file; determining an index result according to a position information of the data to be read and a first index information of the first storage file; reading first sub-data from the first storage file when the index result indicates that the first storage file includes the first sub-data, where the data to be read includes the first sub-data and second sub-data; and reading the second sub-data from the second storage file according to the position information and at least one index information of the second storage file.

According to another aspect of the present disclosure, an electronic device is provided, including: at least one processor; and a memory communicatively connected to the at least one processor, where the memory stores instructions executable by the at least one processor, and the instructions are configured to, when executed by the at least one processor, cause the at least one processor to perform the method described above.

According to another aspect of the present disclosure, a non-transitory computer-readable storage medium storing computer instructions is provided, where the computer instructions are configured to, when executed by a computer, cause the computer to perform the method described above.

It should be understood that the content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute any limitation to the present disclosure. In the accompanying drawings:

FIG. 1 schematically shows an exemplary system architecture to which a data processing method and apparatus may be applied according to an embodiment of the present disclosure;

FIG. 2 schematically shows a flowchart of a data processing method according to an embodiment of the present disclosure;

FIG. 3 schematically shows a scenario diagram of determining an index result according to an embodiment of the present disclosure;

FIG. 4 schematically shows an application scenario diagram of reading first sub-data according to an embodiment of the present disclosure;

FIG. 5 schematically shows a scenario diagram of reading second sub-data according to an embodiment of the present disclosure;

FIG. 6 schematically shows a scenario diagram of reading second sub-data based on a second index information and a third index information according to an embodiment of the present disclosure;

FIG. 7 schematically shows a scenario diagram of updating a second index information after compacting data within a second storage file according to an embodiment of the present disclosure;

FIG. 8 schematically shows a flowchart of migrating data from a first storage file to a second storage file according to another embodiment of the present disclosure;

FIG. 9 schematically shows a flowchart of storing data to be stored into a second storage file according to still another embodiment of the present disclosure;

FIG. 10 schematically shows a block diagram of a data processing apparatus according to an embodiment of the present disclosure; and

FIG. 11 schematically shows a block diagram of an electronic device suitable for implementing the data processing method according to an embodiment of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

Storage based on erasure coding (ec) technology (referred to as ec storage) is typically applied to block storage or file storage that utilizes block storage technology. For example, ec storage configured with 8 data blocks and 12 parity blocks is equivalent to 1.5 replicas, and is suitable for read (Input) and write (Output) operations (IO operations) on data having a large length (size), but not suitable for small IO operations. For example, in ec storage configured with 8 data blocks and 12 parity blocks, the data length of an IO operation is preferably not less than 32 KB. On the one hand, block storage or file storage that utilizes ec storage typically involves a large number of random modifications, especially for data having a small size (data length), referred to as small IO data. Random modifications require reading, modifying, and rewriting data, resulting in severe read/write amplification. On the other hand, ec storage commonly employs hierarchical data structures such as Log Structured Merge Tree (LSM-tree) to convert random modifications into append-only writes, where small IO data are accumulated into large IO data before writing. However, such append-only writes not only logically couple small IO data with large IO data, but also necessitate traversing multiple layers of append-only writes during read operations to locate the corresponding data, resulting in low read efficiency.

In view of the above, embodiments of the present disclosure provide a data processing method, including: in response to receiving a data reading request, determining a first storage file and a second storage file according to an identifier of data to be read in the data reading request, where a storage mode of the first storage file is different from that of the second storage file, and a data length of the second storage file is greater than that of the first storage file; determining an index result according to a position information of the data to be read and a first index information of the first storage file; reading first sub-data from the first storage file when the index result indicates that the first storage file includes the first sub-data, where the data to be read includes the first sub-data and second sub-data; and reading the second sub-data from the second storage file according to the position information and at least one index information of the second storage file.

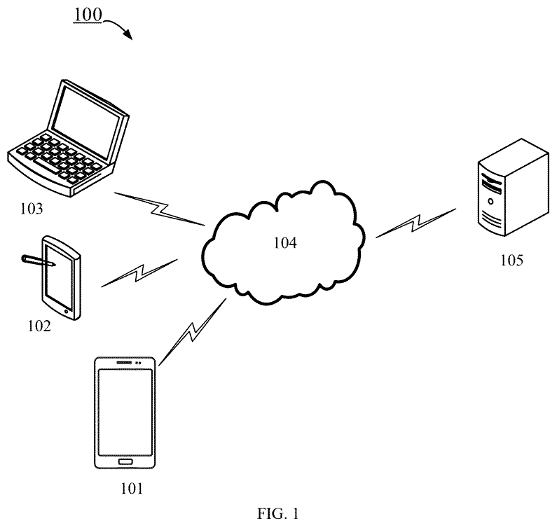

FIG. 1 schematically shows an exemplary system architecture to which a data processing method and apparatus may be applied according to an embodiment of the present disclosure.

It should be noted that FIG. 1 is merely an example of the system architecture to which embodiments of the present disclosure may be applied, so as to help those skilled in the art understand technical contents of the present disclosure. However, it does not mean that embodiments of the present disclosure may not be applied to other devices, systems, environments, or scenarios.

As shown in FIG. 1, a system architecture 100 according to this embodiment may include terminal devices 101, 102, and 103, a network 104, and a server 105. The network 104 serves as a medium for providing a communication link between the terminal devices 101, 102, 103 and the server 105. The network 104 may include various types of connections, such as wired and/or wireless communication links.

The terminal devices 101, 102, and 103 may be used by a user to interact with the server 105 through the network 104 to receive or send messages, etc. The terminal devices 101, 102, and 103 may be installed with various communication client applications, such as knowledge reading applications, web browser applications, search applications, instant messaging tools, email clients, and/or social platform software, etc. (merely as examples).

The terminal devices 101, 102, and 103 may be various electronic devices having display screens and supporting web browsing, including but not limited to smart phones, tablet computers, laptop computers, and desktop computers, etc.

The server 105 may be a server providing various services, such as a background management server (merely as an example) that provides support for content browsed by the user using the terminal devices 101, 102, and 103. The background management server may analyze and process received data such as a user request, and return a processing result (such as a web page, information or data acquired or generated according to the user request) to the terminal devices.

The server may be a cloud server, also known as a cloud computing server or cloud host, which is a host product in a cloud computing service system to solve shortcomings of difficult management and poor service scalability existing in traditional physical hosts and VPS (Virtual Private Server) services. The server may also be a server of a distributed system, or a server integrated with block-chain technology.

It should be noted that the data processing method provided in embodiments of the present disclosure may generally be performed by the server 105. Accordingly, the data processing apparatus provided in embodiments of the present disclosure may also be disposed in the server 105. The data processing method provided in embodiments of the present disclosure may also be performed by a server or server cluster different from the server 105 and capable of communicating with the terminal devices 101, 102, 103 and/or the server 105. Accordingly, the data processing apparatus provided in embodiments of the present disclosure may be disposed in a server or server cluster different from the server 105 and capable of communicating with the terminal devices 101, 102, 103 and/or the server 105.

For example, a user may interact with the terminal devices 101, 102, and 103, such that the terminal devices 101, 102, and 103 generate and transmit a data reading request to the server 105. In response to receiving the data reading request, the server 105 may determine a first storage file and a second storage file according to an identifier of data to be read in the data reading request, where a storage mode of the first storage file is different from that of the second storage file, and a data length of the second storage file is greater than that of the first storage file. The server 105 may determine an index result according to a position information of the data to be read and a first index information of the first storage file. When the index result indicates that the first storage file includes first sub-data, the server 105 may read the first sub-data from the first storage file, where the data to be read includes the first sub-data and second sub-data. The server 105 may then read the second sub-data from the second storage file according to the position information and at least one index information of the second storage file. The server 105 may return the read data to the terminal devices 101, 102, and 103.

It should be understood that the number of terminal devices, networks, and servers illustrated in FIG. 1 is merely exemplary. According to implementation requirements, any number of terminal devices, networks, and servers may be employed.

In embodiments of the present disclosure, the collection, storage, use, processing, transmission, provision, disclosure, and application of user personal information involved all comply with relevant laws and regulations, adopt necessary confidentiality measures, and do not violate public order and good customs.

In the technical solutions of the present disclosure, user authorization or consent is obtained prior to the acquisition or collection of any user personal information.

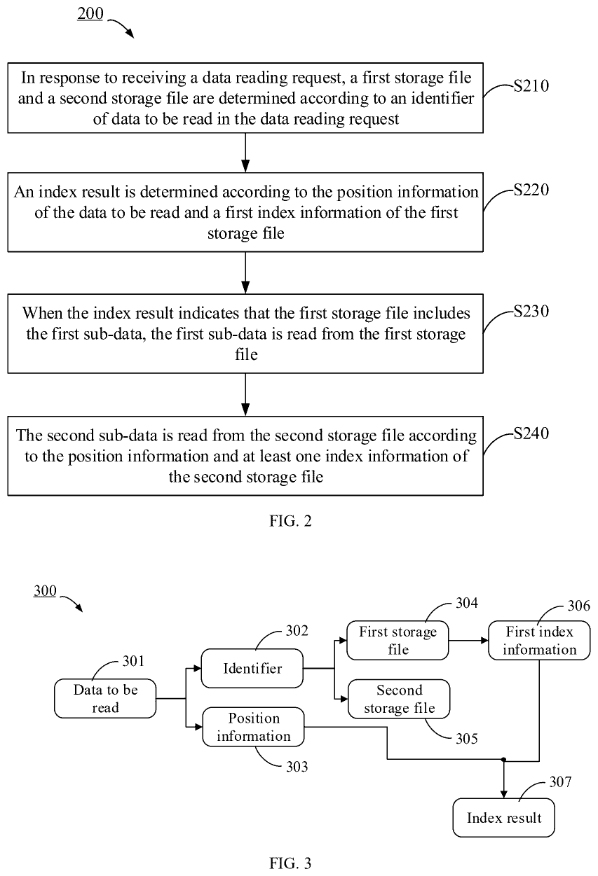

FIG. 2 schematically shows a flowchart of a data processing method according to an embodiment of the present disclosure. As shown in FIG. 2, embodiment 200 includes operation S210 to operation S240.

In operation S210, in response to receiving a data reading request, a first storage file and a second storage file are determined according to an identifier of data to be read in the data reading request.

The data reading request includes the identifier of the data to be read. For example, the identifier may be an identifier of a file to which the data to be read belongs. In addition, the data reading request may further include a position information of the data to be read in the file, so that the data to be read may be retrieved from the file based on the identifier and the position information.

The data to be read may include data at multiple positions and is not limited to data stored entirely at a single position. For example, the data to be stored may be distributed across multiple positions in the first storage file and/or the second storage file.

The data to be read may have been stored through multiple storage operations, and the data lengths of the data stored by the multiple storage operations may be different. Accordingly, the data to be read may be stored in both the first storage file and the second storage file. For example, a portion of the data to be read may be stored in the first storage file, and another portion may be stored in the second storage file.

The storage mode of the first storage file is different from that of the second storage file, and the data length of the second storage file is greater than that of the first storage file. For example, using a length threshold as a boundary, data having a data length greater than the length threshold is stored in the second storage file, whereas data having a data length less than or equal to the length threshold is stored in the first storage file. In an embodiment, the storage mode of the first storage file may be a storage mode suitable for storing small-length data, such as three-replica storage in multi-replica storage; and the storage mode of the second storage file may be a storage mode suitable for storing large-length data, such as ec storage.

For example, the first storage file and the second storage file may correspond to an upper layer (overlay layer) and a lower layer (underlay layer) of a storage layer. For the first storage file using a multi-replica storage mode for storage, the storage layer may include a substantive storage file for storage. For the second storage file using an ec storage mode for storage, it may refer to a physical space (value) mapped from a logical space (key) in a key-value database.

In operation S220, an index result is determined according to the position information of the data to be read and a first index information of the first storage file.

The first index information is used to indicate a validity state of data stored at each position in the first storage file. For example, if data A1 is stored at position A in the first storage file, the first index information may indicate that the data stored at position A is in a valid state.

For the data to be read, an index result may be determined according to the position information of the data to be read and the first index information of the first storage file. For example, if the first index information indicates that the data corresponding to the position information is in an invalid state, the index result may indicate that the first storage file does not include the data to be read. If the first index information indicates that a portion of the data corresponding to the position information is in a valid state, the index result may indicate that the first storage file includes a portion of the data to be read, such as first sub-data.

In operation S230, the first sub-data is read from the first storage file when the index result indicates that the first storage file includes the first sub-data.

The data to be read includes the first sub-data and second sub-data. Since the data to be read may be stored in both the first storage file and the second storage file, for ease of understanding, the portion or all of the data to be read that is stored in the first storage file is referred to as the first sub-data, and the portion or all of the data to be read that is stored in the second storage file is referred to as the second sub-data.

If the first index information indicates that the data at the position of the first sub-data is in a valid state, the first sub-data may be read from the first storage file according to the first index information.

In practical applications, most random modifications in block storage or file storage involve data having small data lengths within 16K. Therefore, when reading data, a search is first performed on the first storage file that stores data having small data lengths, according to the first index information, so as to obtain an index result. The second sub-data that is not included in the first storage file may then be read, through the following operation S240, from the second storage file which stores data having large data lengths.

In operation S240, the second sub-data is read from the second storage file according to the position information and at least one index information of the second storage file.

Similar to the first storage file having its own first index information, the second storage file also has its own at least one index information. The at least one index information is used to indicate the validity state of data stored at each position in the second storage file. In some embodiments, the second storage file may directly locate the physical space of the data in the second storage file through a single index information. In other embodiments, the second storage file may first locate the logical space of the data and then locate the physical space of the data through a plurality of index information.

For the second sub-data in the data to be read, a position information of the second sub-data may be determined according to the position information of the data to be read and the position information of the first sub-data; then the second sub-data may be read from the second storage file according to the position information of the second sub-data. Alternatively, after the position information of the second sub-data is determined, it may be determined whether the second storage file includes the second sub-data according to the at least one index information. If the second storage file includes the second sub-data, the second sub-data may be read from the second storage file.

In embodiments of the present disclosure, data having different data lengths are stored in the first storage file and the second storage file using different storage modes. The first storage file has its own first index information, and the second storage file has its own at least one index information. Accordingly, data having different data lengths are decoupled in terms of storage and reading manners, thereby avoiding complex operations and inefficient operations caused by coupling processing logics for different data lengths, and improving reading efficiency. Furthermore, based on the characteristic that random modifications frequently occur to data having small data lengths in block storage, the first sub-data in the target data is first read from the first storage file, and then the second sub-data is read from the second storage file, thereby minimizing the search and reading of data having large data lengths and further improving reading efficiency.

According to embodiments of the present disclosure, determining the index result according to the position information of the data to be read and the first index information of the first storage file includes: determining, from the first index information, a plurality of first values matching the position information, where the first values indicate validity states of data in the first storage file; and determining the index result according to the plurality of first values.

A data structure of the first index information may include a plurality of first values arranged in the order of data positions in the physical space, and a first value at a given position indicates a validity state of the data stored at that position.

In an embodiment, each position in the first index information may correspond to a data block having a data length unit of 4K, and each first value at a position indicates whether the 4K data block at that position is occupied by data. If the data block is occupied by data, the data stored at that position is in a valid state; otherwise, if the data block is not occupied by data, the data stored at that position is in an invalid state. In addition, since the data length is a relative concept, the unit size of the data block at the corresponding positon in the first index information may vary. The unit size may be determined according to the size of the aligned data block in the physical space, for example, the first index information may be established in units of 512B.

The position information of the data to be read may include an offset and a data length, and may be represented in the form of (offset, length). According to the offset and the data length, a position of a data block that may be occupied by the data to be read may be located from the first index information.

For example, the position information of the data to be read may be (0K, 8K), (12K, 4K), and (16K, 4K). According to the above position information, it is possible to determine, from the first index information, the first values of the first and second data blocks (corresponding to the data having an offset of 0K and a data length of 8K), the fourth data block (corresponding to the data having an offset of 12K and a data length of 4K), and the fifth data block (corresponding to the data having an offset of 16K and a data length of 4K).

For the plurality of first values determined from the first index information, the validity state of the data at the position corresponding to each first value may be determined according to a specific value of the first value. In a specific embodiment, the first index information may be a bitmap, and each first value may be either 0 or 1, where 0 indicates that the data is in an invalid state and 1 indicates that the data is in a valid state.

In embodiments of the present disclosure, by first determining a plurality of first values matching the position information from the first index information and then determining an index result according to the plurality of first values, it may be determined whether the first storage file stores all or part of the data to be read according to the first index information of the first storage file, so that the reading operation for the data to be read may be preferentially performed based on the first storage file that stores small-length data, thereby avoiding unnecessary searching and reading of large-length data and further improving reading efficiency.

FIG. 3 schematically shows a scenario diagram of determining an index result according to an embodiment of the present disclosure. As shown in FIG. 3, in embodiment 300, an identifier 302 and a position information 303 of data to be read 301 may be parsed from a data reading request, and a first storage file 304 and a second storage file 305 are determined according to the identifier 302. An index result 307 may be determined according to the position information 303 and a first index information 306 of the first storage file 304.

According to embodiments of the present disclosure, determining the index result according to the plurality of first values includes: determining a first index result when all of the plurality of first values indicate a valid state, where the first index result indicates that the first storage file includes the data to be read; determining a second index result when all of the plurality of first values indicate an invalid state, where the second index result indicates that the second storage file includes the data to be read; and determining a third index result when a portion of the plurality of first values indicates a valid state, where the third index result indicates that the first storage file includes the first sub-data, and the data at positions matching the portion of the plurality of first values indicating the valid state is the first sub-data.

The first storage file and the second storage file may be pre-allocated for the data to be read, but the first storage file and the second storage file may temporarily not contain the data to be read. Therefore, according to the plurality of first values determined from the first index information, three different index results may be obtained, which are distinguished below as first, second, and third index results.

When all of the plurality of first values indicate a valid state, the first index result may be obtained, which means that the data to be read is entirely stored in the first storage file. In this case, the data to be read may be directly read from the first storage file, without the need to operate on the at least one index information of the second storage file or perform any reading operation on the second storage file, thereby improving reading efficiency in random modification scenarios where small-length data accounts for a high proportion.

When all of the plurality of first values indicate an invalid state, the second index result may be obtained, which means that the data to be read is entirely stored in the second storage file. In this case, the data to be read may be read from the second storage file, thereby supporting random modification scenarios involving large-length data.

When a portion of the plurality of first values indicates a valid state, the data to be stored is divided into first sub-data and second sub-data, which are stored in the first storage file and the second storage file, respectively. In embodiments of the present disclosure, since the search is first performed on the first index information of the first storage file, the first sub-data in the first storage file may be preferentially read, and then the second sub-data is read from the second storage file, thereby reducing searching and reading operations for large-length data and improving reading efficiency.

In a specific embodiment where the first storage file uses a multi-replica storage mode for storage and the second storage file uses an ec storage mode for storage, since random modifications to small-length data in ec storage may cause severe read/write amplification, the ec storage mode is employed to store large-length data in the embodiment of the present disclosure. When reading data, the first sub-data having small data lengths stored in the multi-replica storage mode are preferentially read, and then the second sub-data is read from the second storage file, thereby reducing the read/write amplification caused by the ec storage mode itself and further improving reading efficiency and storage efficiency.

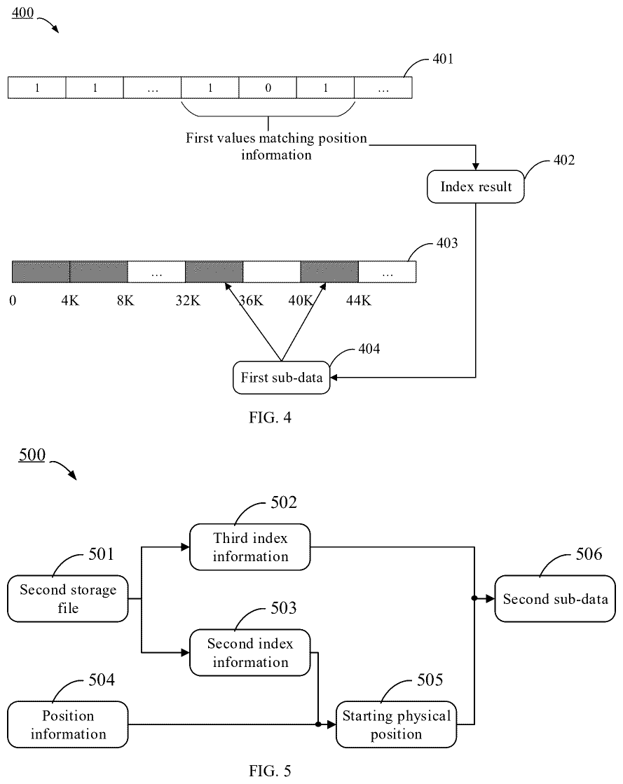

FIG. 4 schematically shows an application scenario diagram of reading first sub-data according to an embodiment of the present disclosure. As shown in FIG. 4, embodiment 400 includes a first storage file 403 and a first index information 401 of the first storage file 403. The first index information 401 may be a bitmap, where the first values 0 and 1 respectively represent an invalid state and a valid state of data.

According to the position information of the data to be read, a plurality of first values matching the position information may be determined from the first index information 401. For example, the plurality of first values may be {1, 0, 1}. According to the specific values of the plurality of first values, an index result 402 may be determined. For example, the data at the positions corresponding to the two values of 1 among the plurality of first values are in a valid state, and the data at the position corresponding to the value of 0 is in an invalid state. Because a fixed mapping relationship exists between the positions in the first index information 401 and those in the first storage file 403, the data at positions 32K-36K and 40K-44K may be read from the first storage file 403 according to the positions of the two values of “1” in the first index information 401, and the data at positions 32K-36K and 40K-44K constitute the first sub-data 404. The missing second sub-data at positions 36K-40K may be read from the second storage file.

According to embodiments of the present disclosure, with respect to operation S240, reading the second sub-data from the second storage file according to the position information and at least one index information of the second storage file includes: determining a starting physical address of third sub-data in the second storage file according to the position information and a second index information of the second storage file, where the third sub-data is a portion of the data to be read other than the first sub-data; and reading the second sub-data from the second storage file according to the starting physical address and a third index information of the second storage file, where the second sub-data is valid data in the third sub-data.

The second storage file may include two index information, such as a second index information and a third index information. The second index information is used to indicate the starting physical address of each data in the second storage file, and the third index information is used to indicate the position of each data within the second storage file in the physical space. The second index information may be regarded as an index information aligning the logical space of data with the physical space of data.

Since the first storage file stores the first sub-data of the data to be read, the remaining third sub-data of the data to be read and its position information may be determined according to the position information of the data to be read and the position information of the first sub-data. Therefore, according to the position information of the third sub-data, such as an offset of the third sub-data, a starting physical address of the third sub-data in the second storage file may be determined from the second index information. Subsequently, the second sub-data may be located and read from the second storage file according to the starting physical address, the length in the position information, and the third index information.

In an embodiment, all the third sub-data in the second storage file is valid data, and then the second sub-data is identical to the third sub-data. In another embodiment, only a valid portion of the third sub-data is stored in the second storage file, then the second sub-data read from the second storage file differs from the third sub-data, and the second sub-data includes only a portion of the third sub-data.

It may be understood that when it fails to determine the starting physical address of the third sub-data in the second storage file according to the position information and the second index information, it indicates that the third sub-data in the second storage file is entirely in an invalid state. In this case, the second sub-data cannot be read from the second storage file, and it is unnecessary to further process the third index information. A value of 0 may be directly returned to indicate that no second sub-data has been read, thereby improving reading efficiency. Alternatively, if it is determined according to the third index information that the third sub-data in the second storage file is entirely in an invalid state, a value of 0 may be returned to indicate that no second sub-data has been read, thereby improving reading efficiency.

In embodiments of the present disclosure, by determining the starting physical address of the third sub-data in the second storage file according to the position information and the second index information of the second storage file, and by reading the second sub-data from the second storage file according to the starting physical address and the third index information of the second storage file, it is possible to first rapidly locate the starting physical address of the third sub-data according to the second index information, thereby improving the efficiency of subsequently reading the second sub-data in a valid state from within the third sub-data.

FIG. 5 schematically shows a scenario diagram of reading second sub-data according to an embodiment of the present disclosure. As shown in FIG. 5, in embodiment 500, a second storage file 501 includes a second index information 503 and a third index information 502. A position information 504 of the third sub-data may be determined according to the position information of the data to be read and the position information of the first sub-data. Further, a starting physical address 505 of the third sub-data in the second storage file may be determined according to the second index information 503 and the position information 504 of the third sub-data. The second sub-data 506 may then be read from the second storage file according to the starting physical address 505 and the third index information 502.

According to embodiments of the present disclosure, reading the second sub-data from the second storage file according to the starting physical address and the third index information of the second storage file includes: acquiring, from the third index information, a target number of second values following the starting physical address, where the target number is determined according to a data length of the third sub-data; and reading the second sub-data from the second storage file according to the target number of second values, where at least one of the target number of second values indicates a valid state, and the data at positions matching the at least one second value is the second sub-data.

For example, a data structure of the third index information may include a plurality of second values arranged in the order of data positions in the physical space, and a data structure of the second index information may include a plurality of third values arranged in the order of starting physical addresses of data. For example, if the third value corresponding to a starting physical address B is a predetermined value, it indicates that the starting physical address of data B1 is B.

In a specific embodiment, both the second index information and the third index information may be bitmaps. When the third value in the second index information is 1 (i.e., the predetermined value is 1), the starting physical address of data B1 is B; when the second value in the third index information is 1, it indicates that the data at that position is in a valid state.

It should be noted that, according to the order of appearance of the second index information and the third index information, the values in the third index information are referred to as second values, and the values in the second index information are referred to as third values.

In an embodiment, each position in the third index information may correspond to a data block having a data length unit of 4K, and each second value at the corresponding position indicates whether the 4K data block at that position is occupied by data. If the data block is occupied by data, the data stored at that position is in a valid state. For the third sub-data, if the position information of the third sub-data is (0K, 1024K), (1536K, 512K), and (2048K, 512K), then the target numbers may be 1024K/4K=256, 1536K/4K=384, and 2048K/4K=512.

Similar to determining the plurality of first values from the first index information, a target number of second values matching the third sub-data may be determined from the third index information after determining the starting physical address and the data length of the third sub-data. According to whether the target number of second values indicate a valid state, it may be determined whether the second storage file includes valid data. If all of the target number of second values in the third index information indicate a valid state, the second sub-data is identical to the third sub-data. If only at least one of the target number of second values indicates a valid state, then the data at the position matching the at least one second value is the second sub-data, and only the second sub-data needs to be read from the second storage file.

In embodiments of the present disclosure, by acquiring a target number of second values following the starting physical address from the third index information and reading the second sub-data in a valid state from the second storage file according to the target number of second values, only the data in a valid state is read according to the third index information during the reading operation, without reading the data in an invalid state, thereby further improving reading efficiency.

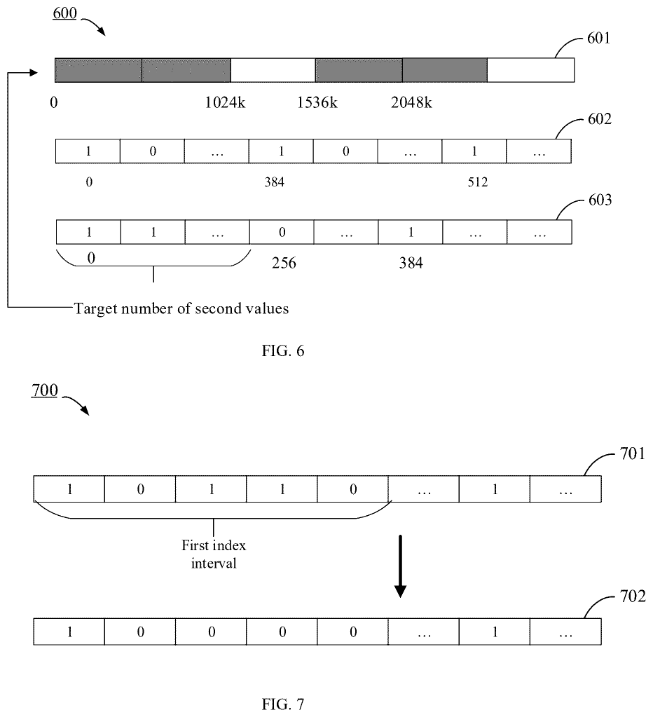

FIG. 6 schematically shows a scenario diagram of reading second sub-data based on a second index information and a third index information according to an embodiment of the present disclosure. As shown in FIG. 6, in embodiment 600, the physical space of a second storage file 601 stores three data segments respectively having physical addresses (0K, 1024K), (1536K, 512K), and (2048K, 512K).

The offset in the position information of the third sub-data may be understood as a logical address in the logical space. When the logical address is 0K, it may be determined from the second index information 602 of the second storage file 601 that the starting physical address of the third sub-data is also 0K. Therefore, according to the data length of 1024K and the starting physical address of 0K of the third sub-data, a target number of second values may be determined from the third index information 603, for example, 256 second values located at positions 0-255 in the third index information 603. In this embodiment, all of the 256 second values are equal to 1, indicating that the stored data is valid data. Therefore, the data at address (0K, 1024K) may be read from the first storage file, and such data is the second sub-data. In this embodiment, the second sub-data is identical to the third sub-data.

According to embodiments of the present disclosure, the data processing method further includes: determining a first index interval having a fragmentation rate exceeding a predetermined threshold in the second storage file according to the second index information; and compacting data within the second storage file according to the third index information and the first index interval.

In embodiments of the present disclosure, for the second storage file that stores large-length data, it is noted that random modifications to small-length data may cause partial data in the second storage file to become invalid data, thereby resulting in the large-length data stored in the second storage file becoming fragmented valid data. Accordingly, data compaction may be periodically performed on the data within the second storage file to improve locality of data access.

Since the second index information indicates the starting physical address of each data segment in the second storage file, the number of data segments included in the second storage file may be determined according to the second index information, and thus a degree of fragmentation of the data in the second storage file may be measured.

For example, the second index information may be divided into a plurality of index intervals. For each index interval, the fragmentation rate may be determined according to a ratio of the number of third values equal to a predetermined value to a total number of third values in that index interval. The predetermined threshold may be defined according to actual requirements.

When the fragmentation rate of a first index interval exceeds a predetermined threshold, it indicates that the data in the first index interval has a high degree of fragmentation. In this case, the data in the second storage file falling within the first index interval may be compacted according to the third index information and the first index interval.

In embodiments of the present disclosure, by determining the first index interval having a fragmentation rate exceeding the predetermined threshold in the second storage file according to the second index information, the degree of fragmentation of the data in the second storage file may be rapidly determined without reading the data. Subsequently, the data in the second storage file may be compacted according to the third index information and the first index interval. According to embodiments of the present disclosure, highly fragmented data in the second storage file (for example, which using an ec storage mode for storage) may be accurately and efficiently identified, and such data may be compacted, thereby avoid severe read/write amplification that may otherwise occur during data reorganization and compaction.

According to embodiments of the present disclosure, determining the first index interval having a fragmentation rate exceeding the predetermined threshold in the second storage file according to the second index information includes: acquiring a plurality of third values of each second index interval in the second index information; determining the fragmentation rate of each second index interval according to the plurality of third values; and determining the second index interval having a fragmentation rate exceeding the predetermined threshold as the first index interval.

A plurality of second index intervals having a preset length may be defined as required. For example, a sliding window of a preset length may be provided, and a plurality of second index intervals of the preset length may be obtained by moving the sliding window from the head of the second storage file. Alternatively, the second storage file may be divided from its head into a plurality of second index intervals according to the preset length. The length of the last second index interval may be less than or greater than the preset length, as long as the fragmentation rate of the index interval may be determined.

For each second index interval, the fragmentation rate of the second index interval may be determined according to a ratio of the number of third values equal to the predetermined value to the total number of third values in the second index interval. The second index interval having a fragmentation rate exceeding the predetermined threshold may be determined as the first index interval.

For example, the second index information may be a bitmap, where each 256 bits represent a 1-MB address space. The second index information may be divided into second index intervals with 256 bits as the preset length, and the predetermined value is 1. Therefore, the fragmentation rate of each second index interval may be determined according to the number of third values equal to 1 among the 256 bits and the total number of third values, e.g., 256. For example, the fragmentation rate x may be expressed as x=n/256, where n is the number of bits having the value 1. A greater number of bits having the value 1 in the second index interval indicates a greater number of data in the second index interval, and thus a higher fragmentation rate of the second index interval.

For example, a second index interval having a fragmentation rate greater than 50% may be determined as a first index interval requiring compaction.

In embodiments of the present disclosure, by dividing the second index information into a plurality of second index intervals, the degree of fragmentation of local data within the second index information may be further evaluated, and the intervals having a high local fragmentation degree in the second index information may be accurately identified, thereby enabling finer-grained data compaction, and improving the efficiency of local data reading while reducing the data read amplification.

According to embodiments of the present disclosure, compacting the data within the second storage file according to the third index information and the first index interval includes: acquiring a plurality of second values within the first index interval from the third index information; reading valid data from the second storage file according to the plurality of second values; compacting the valid data; and re-storing the compacted valid data into the second storage file and updating the second index information.

A plurality of valid data may be scattered in the first index interval, and the third index information may indicate the validity state of data at each position through the second values. After the first index interval is determined, by acquiring the plurality of second values within the first index interval from the third index information, the valid data in the first index interval may be determined and then a reading operation may be performed.

For example, both the second index information and the third index information may be bitmaps. The first index interval determined according to the second index information may be an interval of 256 bits, ranging from 0 to 255. The second values corresponding to the 256 bits may be acquired from the third index information, and each second value may be either 0 or 1, where 1 indicates that the data at that position is in a valid state, that is, the data is valid data.

The valid data thus determined may be directly read from the second storage file according to the third index information, without the need to read other invalid data from the second storage file, thereby reducing the amount of data reading. For the read valid data, two or more valid data may be compacted to obtain compacted valid data. It may be understood that the quantity of valid data after compaction is less than the quantity of valid data before compaction. Therefore, after the compacted valid data is stored into the second storage file, the degree of fragmentation of the data in the second storage file is reduced.

Since the quantity of valid data changes after the compaction operation, the starting physical address of each data also changes. Accordingly, when restoring the compacted valid data into the second storage file, it is needed to synchronously update the second index information.

In embodiments of the present disclosure, the positions of valid data in the second storage file may be determined according to the plurality of second values within the first index interval in the third index information. Therefore, according to embodiments of the present disclosure, it is possible to only read valid data from the second storage file, without the need to read all data from the second storage file for validity determination and compaction, thereby avoiding the read/write amplification caused by compaction of the second storage file.

FIG. 7 schematically shows a scenario diagram of updating the second index information after compaction of data within the second storage file according to an embodiment of the present disclosure. As shown in FIG. 7, embodiment 700 includes a second index information 701 before compaction and a second index information 702 after compaction.

In the second index information 701 before compaction, the fragmentation rate of the first index interval is 3/5=60%, which is greater than 50%. Accordingly, the three valid data segments in the first index interval may be compacted and re-stored starting from the position of 0K. In the second index information 702 after compaction, the three valid data segments are compacted into a single valid data segment.

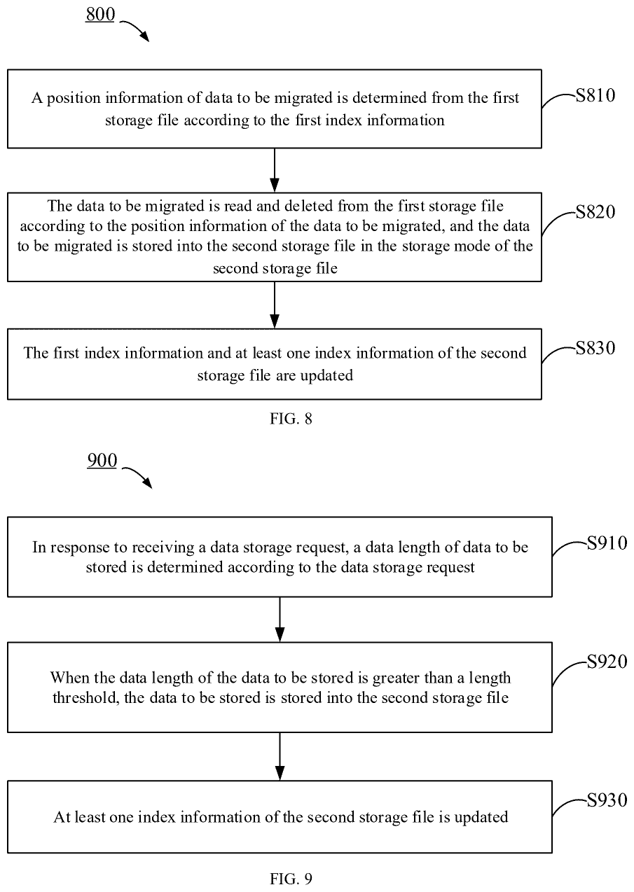

FIG. 8 schematically shows a flowchart of migrating data from the first storage file to the second storage file according to another embodiment of the present disclosure.

As shown in FIG. 8, embodiment 800 includes operation S810 to operation S830.

In operation S810, a position information of data to be migrated is determined from the first storage file according to the first index information.

The data to be migrated includes a plurality of valid data stored at consecutive addresses in the first storage file. Relative to the second storage file, the first storage file is used to store small-length data. However, during multiple random modifications, small-length data may accumulate into large-length data. In such cases, a plurality of small-length data may be stored using a storage mode for storing large-length data.

For example, the data length of the second storage file may serve as a threshold. When a total data length of a plurality of valid data at consecutive addresses in the first storage file is greater than or equal to the data length of the second storage file, the plurality of valid data at consecutive addresses are determined as data to be migrated.

Since the first index information indicates the validity state of data stored at each position in the first storage file, the position information of the data to be migrated may be determined according to the first index information.

In operation S820, the data to be migrated is read and deleted from the first storage file according to the position information of the data to be migrated, and the data to be migrated is stored into the second storage file in the storage mode of the second storage file.

According to the position information of the data to be migrated, a plurality of valid data stored at consecutive addresses may be read from the first storage file, and the plurality of valid data stored at consecutive addresses may be regarded as a complete data to be migrated. The data to be migrated may then be stored using the storage mode of the second storage file. To avoid duplication of the data to be migrated between the first storage file and the second storage file, the data to be migrated may be synchronously deleted from the first storage file after being read from the first storage file.

In operation S830, the first index information and at least one index information of the second storage file are updated.

After the data to be migrated is transferred from the first storage file to the second storage file, it is necessary to update the first index information of the first storage file and at least one index information of the second storage file in order to facilitate accurate subsequent reading of the migrated data.

For example, assuming that the first index information is a bitmap, if 150 values of 1 consecutively appear starting from position 0K in the first index information, the total data length of the valid data at the positions corresponding to the values of 1 is 4K×150=600K, which is greater than the data length 500K of the second storage file. In this case, the 150 consecutive data from 0K to 600K may be determined as data to be migrated, and the position information is (0K, 4K), (4K, 4K), (8K, 4K), (12K, 4K), and so on. After each data in the data to be migrated is sequentially read from the first storage file according to the above-determined position information, the 150 data are concatenated into a single large-length data, which is then stored in the storage mode corresponding to the second storage file, such as ec storage. To avoid duplication of the data to be migrated between the first storage file and the second storage file, after the data to be migrated is read from the first storage file, the data to be migrated is synchronously deleted from the first storage file, and the first values at the corresponding positions in the first index information are updated to 0.

Similarly, when the data to be migrated is stored into the second storage file, at least one index information of the second storage file is updated so that the migrated data may subsequently be read from the second storage file. For example, if the second storage file includes the second index information and the third index information described above, both in the form of bitmaps, the third value corresponding to the starting physical address of the migrated data in the second index information may be updated to 1, and the second values at positions corresponding to the migrated data in the third index information may be updated to 1.

In embodiments of the present disclosure where the first storage file and the second storage file are decoupled from each other, for small-length data, by determining the position information of the data to be migrated from the first storage file according to the first index information, reading and deleting the data to be migrated from the first storage file according to the position information of the data to be migrated, and then storing the data to be migrated into the second storage file in the storage mode of the second storage file, the scattered small-length valid data may be compacted into large-length data and flushed down to the second storage file, thereby reducing the quantity of small-length data, improving the processing efficiency of small-length data, and enhancing the locality of data access.

FIG. 9 schematically shows a flowchart of storing data to be stored into the second storage file according to still another embodiment of the present disclosure. As shown in FIG. 9, embodiment 900 includes operation $910 to operation S930. Operations S910 to S930 may be implemented as an embodiment of storing data into the first storage file or the second storage file during random modification and/or data writing. The data to be read or the data to be migrated described above may be stored into the first storage file or the second storage file through operations S910 to S930.

In operation S910, in response to receiving a data storage request, a data length of data to be stored is determined according to the data storage request.

In operation S920, the data to be stored is stored into the second storage file if the data length of the data to be stored is greater than a length threshold.

In operation S930, at least one index information of the second storage file is updated.

The data storage request may include the data length, for example, referred to as length. The data length of the data to be stored may be obtained by parsing the data storage request.

The first storage file and the second storage file may be differentiated based on a predetermined length threshold. For example, the length threshold may be set to 4K, 500K, etc., and may be determined according to actual requirements. When the data length of the data to be stored is less than or equal to the length threshold, the data to be stored is stored into the first storage file in the storage mode of the first storage file, and the first index information of the first storage file is updated; otherwise, the data to be stored is stored into the second storage file, and at least one index information of the second storage file is updated.

For example, when the data length of the data to be stored is greater than the length threshold, the data to be stored is stored into the second storage file in an ec storage mode, and the second index information and the third index information of the second storage file are updated. When the data length of the data to be stored is less than or equal to the length threshold, the data to be stored is stored into the first storage file in a multi-replica storage mode, such as a three-replica storage mode, and the first index information is updated.

In embodiments of the present disclosure, data to be stored having a small data length may be written directly into the first storage file, without waiting for the accumulation of small-length data into large-length data before storage. Thus, according to embodiments of the present disclosure, write latency caused by waiting for accumulation of small-length data into large-length data may be avoided. Moreover, for data to be stored having a small data length, only the data in the first storage file and the index of the first storage file need to be modified, and the processing operations for small-length data are decoupled from the processing operations for large-length data in the second storage file, thereby preventing the processing operations for small-length data from affecting the processing operations for large-length data, and improving the processing efficiency of small-length data. Only when the data length of the data to be stored exceeds the length threshold, the storage mode suitable for large-length data is used for storage, thereby minimizing the read/write amplification that would otherwise occur if small-length data were stored in the storage mode corresponding to the second storage file.

For example, in an embodiment where the second storage file uses ec storage and the first storage file uses multi-replica storage, by storing small-length data in the multi-replica storage mode and storing large-length data in the ec storage mode, the problems of read/write amplification and low IO efficiency associated with ec storage for random modification and small-length data may be solved, thereby improving data reading and storage efficiency.

In a specific embodiment, considering that the distribution of data lengths is uneven in practical applications, data storage and reading (IO) operations are mainly concentrated on data having a data length less than or equal to 16K (small-length data) and data having a data length greater than or equal to 500K (large-length data).

For example, the length threshold may be set to 16K, and data having a data length less than or equal to 16K may be stored in the first storage file, while data having a data length in a range of 16K to 500K and data having a data length greater than or equal to 500K are regarded as large-length data and may be stored in the second storage file, thereby reducing the quantity of small-length data.

Alternatively, the length threshold may be set to 500K, and data having a data length less than or equal to 500K may be stored in the first storage file, while data having a data length in a range of 16K to 500K and data having a data length less than or equal to 16K are both regarded as small-length data and stored in the first storage file. Since data is first read from the first storage file during a reading operation, storing the data having a data length in the range of 16K to 500K into the first storage file may improve the reading efficiency of such data.

In a specific embodiment, for data to be stored having a data length greater than the length threshold, since the data to be stored may be modified data (including randomly modified data and data modified by user operations), the first storage file may contain data related to the data to be stored. Therefore, in addition to operations S910 to S930, the data processing method further includes: performing historical data detection on the first storage file according to the first index information and the position information of the data to be stored, to obtain a historical detection result; when the historical detection result indicates that the first storage file includes historical data associated with the data to be stored, deleting the historical data from the first storage file; and updating the first index information.

When the data to be stored is modified data, the data storage request includes the position information of the data to be stored. A historical data detection may be performed according to the position information of the data to be stored and the first index information of the first storage file to obtain a historical detection result. For example, a plurality of fourth values matching the position information of the data to be stored may be determined from the first index information. When all of the plurality of fourth values indicate an invalid state, the historical detection result indicates that the first storage file does not include any historical data associated with the data to be stored. Conversely, when at least one of the plurality of fourth values indicates a valid state, the historical detection result indicates that the first storage file includes historical data associated with the data to be stored. In this case, the data at positions corresponding to the at least one fourth value is the historical data. The history data may be deleted from the first storage file, and the at least one fourth value in the first index information may be updated to a value representing an invalid state. The fourth values in the first index information are similar to the first values described above and are only used here to distinguish between reading and storage processes.

In embodiments of the present disclosure, if the historical data in the first storage file is not deleted during data storage, then in subsequent data reading, the historical data may be retrieved because the reading operation starts from the first storage file. As a result, the retrieved data may not be the latest data, thereby affecting the accuracy of data reading.

Therefore, in embodiments of the present disclosure, when the data length of the data to be stored is greater than the length threshold, a historical data detection is performed on the first storage file according to the first index information and the position information of the data to be stored, to obtain a historical detection result. When the historical detection result indicates that the first storage file includes historical data associated with the data to be stored, the historical data is deleted from the first storage file, and the first index information is updated. According to embodiments of the present disclosure, when the data to be stored is stored into the second storage file, it is possible to prevent duplicate historical data from remaining in the first storage file and avoid affecting the accuracy of data reading.

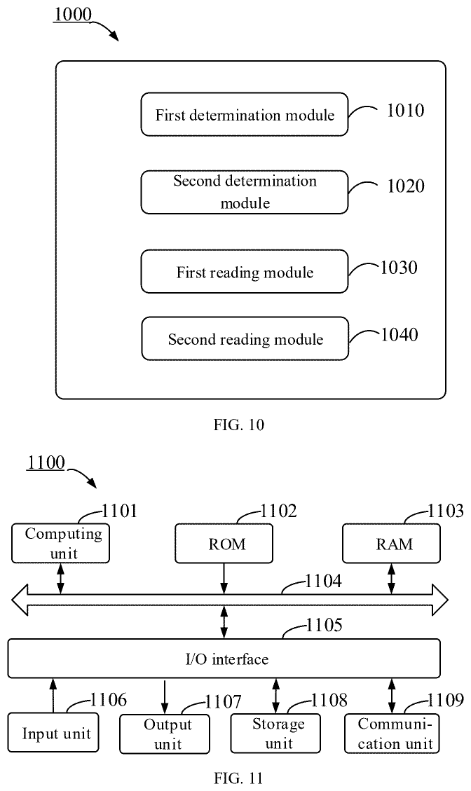

FIG. 10 schematically shows a block diagram of a data processing apparatus according to an embodiment of the present disclosure.

As shown in FIG. 10, a data processing apparatus 1000 includes a first determination module 1010, a second determination module 1020, a first reading module 1030, and a second reading module 1040.

The first determination module 1010 is configured to, in response to receiving a data reading request, determine a first storage file and a second storage file according to an identifier of data to be read in the data reading request, where a storage mode of the first storage file is different from that of the second storage file, and a data length of the second storage file is greater than that of the first storage file.

The second determination module 1020 is configured to determine an index result according to a position information of the data to be read and a first index information of the first storage file.

The first reading module 1030 is configured to read first sub-data from the first storage file when the index result indicates that the first storage file includes the first sub-data, where the data to be read includes the first sub-data and second sub-data.

The second reading module 1040 is configured to read the second sub-data from the second storage file according to the position information and at least one index information of the second storage file.

According to embodiments of the present disclosure, the second determination module 1020 includes a first determination sub-module and a second determination sub-module.

The first determination sub-module is configured to determine a plurality of first values matching the position information from the first index information, where the first values indicate validity states of data in the first storage file.

The second determination sub-module is configured to determine the index result according to the plurality of first values.

According to embodiments of the present disclosure, the second determination sub-module includes a first determination unit, a second determination unit, and a third determination unit.

The first determination unit is configured to determine a first index result when all of the plurality of first values indicate a valid state, where the first index result indicates that the first storage file includes the data to be read.

The second determination unit is configured to determine a second index result when all of the plurality of first values indicate an invalid state, where the second index result indicates that the second storage file includes the data to be read.

The third determination unit is configured to determine a third index result when a portion of the plurality of first values indicates a valid state, where the third index result indicates that the first storage file includes the first sub-data, and the data at positions matching the portion of the plurality of first values indicating the valid state is the first sub-data.

According to embodiments of the present disclosure, the second reading module 1040 includes a first reading sub-module and a second reading sub-module.

The first reading sub-module is configured to determine a starting physical address of third sub-data in the second storage file according to the position information and a second index information of the second storage file, where the third sub-data is a portion of the data to be read other than the first sub-data.

The second reading sub-module is configured to read the second sub-data from the second storage file according to the starting physical address and a third index information of the second storage file, where the second sub-data is valid data in the third sub-data.

According to embodiments of the present disclosure, the second reading sub-module includes: an acquisition unit configured to acquire a target number of second values following the starting physical address from the third index information, where the target number is determined according to a data length of the third sub-data; and a first reading unit configured to read the second sub-data from the second storage file according to the target number of second values, where at least one of the target number of second values indicates a valid state, and the data at positions matching the at least one second value is the second sub-data.

According to embodiments of the present disclosure, the data processing apparatus 1000 further includes: a third determination module configured to determine a first index interval having a fragmentation rate exceeding a predetermined threshold in the second storage file according to the second index information; and a compaction module configured to compact the data within the second storage file according to the third index information and the first index interval.

According to embodiments of the present disclosure, the third determination module includes: an acquisition sub-module configured to acquire a plurality of third values of each second index interval in the second index information; a third determination sub-module configured to determine the fragmentation rate of each second index interval according to the plurality of third values; and a fourth determination sub-module configured to determine the second index interval having a fragmentation rate exceeding the predetermined threshold as the first index interval.

According to embodiments of the present disclosure, the compaction module includes: a data acquisition sub-module configured to acquire a plurality of second values within the first index interval from the third index information; a third reading sub-module configured to read valid data from the second storage file according to the plurality of second values; a compaction sub-module configured to compact the valid data; and a storage sub-module configured to re-store the compacted valid data into the second storage file and update the second index information.

According to embodiments of the present disclosure, the data processing apparatus 1000 further includes: a fourth determination module configured to determine a position information of data to be migrated from the first storage file according to the first index information; a third reading module configured to read and delete the data to be migrated from the first storage file according to the position information of the data to be migrated, and store the data to be migrated into the second storage file in the storage mode of the second storage file; a first updating module configured to update the first index information and at least one index information of the second storage file.

According to embodiments of the present disclosure, the data processing apparatus 1000 further includes: a fifth determination module configured to, in response to receiving a data storage request, determine a data length of data to be stored according to the data storage request; a storage module configured to store the data to be stored into the second storage file when the data length of the data to be stored is greater than a length threshold; and a second updating module configured to update at least one index information of the second storage file.

According to embodiments of the present disclosure, the present disclosure further provides an electronic device, a readable storage medium, and a computer program product.

According to embodiments of the present disclosure, an electronic device is provided, including: at least one processor; and a memory communicatively connected to the at least one processor. The memory stores instructions executable by the at least one processor, and the instructions are configured to, when executed by the at least one processor, cause the at least one processor to implement the method described above.

According to embodiments of the present disclosure, a non-transitory computer-readable storage medium having computer instructions therein is provided, and the computer instructions are configured to cause a computer to implement the method described above.

According to embodiments of the present disclosure, a computer program product containing a computer program is provided, and the computer program is configured to, when executed by a processor, implement the method described above.

FIG. 11 schematically shows a block diagram of an electronic device suitable for implementing the data processing method according to embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 11, the electronic device 1100 includes a computing unit 1101 which may perform various appropriate actions and processes according to a computer program stored in a read only memory (ROM) 1102 or a computer program loaded from a storage unit 1108 into a random access memory (RAM) 1103. In the RAM 1103, various programs and data necessary for an operation of the electronic device 1100 may also be stored. The computing unit 1101, the ROM 1102 and the RAM 1103 are connected to each other through a bus 1104. An input/output (I/O) interface 1105 is also connected to the bus 1104.

A plurality of components in the electronic device 1100 are connected to the input/output (I/O) interface 1105, including: an input unit 1106, such as a keyboard, or a mouse; an output unit 1107, such as displays or speakers of various types; a storage unit 1108, such as a disk, or an optical disc; and a communication unit 1109, such as a network card, a modem, or a wireless communication transceiver. The communication unit 1109 allows the electronic device 1100 to exchange information/data with other devices through a computer network such as Internet and/or various telecommunication networks.

The computing unit 1101 may be various general-purpose and/or dedicated processing assemblies having processing and computing capabilities. Some examples of the computing units 1101 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 1101 executes various methods and processes described above, such as the data processing method. For example, in some embodiments, the data processing method may be implemented as a computer software program which is tangibly embodied in a machine-readable medium, such as the storage unit 1108. In some embodiments, the computer program may be partially or entirely loaded and/or installed in the electronic device 1100 via the ROM 1102 and/or the communication unit 1109. The computer program, when loaded in the RAM 1103 and executed by the computing unit 1101, may execute one or more steps in the data processing method described above. Alternatively, in other embodiments, the computing unit 1101 may be used to perform the data processing method by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the data processing method of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A data processing method, comprising:
in response to receiving a data reading request, determining a first storage file and a second storage file according to an identifier of data to be read in the data reading request, wherein a storage mode of the first storage file is different from that of the second storage file, and a data length of the second storage file is greater than that of the first storage file;
determining an index result according to a position information of the data to be read and a first index information of the first storage file;
reading first sub-data from the first storage file when the index result indicates that the first storage file comprises the first sub-data, wherein the data to be read comprises the first sub-data and second sub-data; and
reading the second sub-data from the second storage file according to the position information and at least one index information of the second storage file.

2. The method of claim 1, wherein the determining an index result according to a position information of the data to be read and a first index information of the first storage file comprises:
determining a plurality of first values matching the position information from the first index information, wherein the plurality of first values indicate validity states of data in the first storage file; and
determining the index result according to the plurality of first values.

3. The method of claim 2, wherein the determining the index result according to the plurality of first values comprises:
determining a first index result when all of the plurality of first values indicate a valid state, wherein the first index result indicates that the first storage file comprises the data to be read;
determining a second index result when all of the plurality of first values indicate an invalid state, wherein the second index result indicates that the second storage file comprises the data to be read; and
determining a third index result when a portion of the plurality of first values indicate a valid state, wherein the third index result indicates that the first storage file comprises the first sub-data, and the data at positions corresponding to the portion of the plurality of first values indicating the valid state are the first sub-data.

4. The method of claim 1, wherein the reading the second sub-data from the second storage file according to the position information and at least one index information of the second storage file comprises:
determining a starting physical address of third sub-data in the second storage file according to the position information and a second index information of the second storage file, wherein the third sub-data is a portion of the data to be read other than the first sub-data; and
reading the second sub-data from the second storage file according to the starting physical address and a third index information of the second storage file, wherein the second sub-data is valid data in the third sub-data.

5. The method of claim 4, wherein the reading the second sub-data from the second storage file according to the starting physical address and a third index information of the second storage file comprises:
acquiring a target number of second values following the starting physical address from the third index information, wherein the target number is determined according to a data length of the third sub-data; and
reading the second sub-data from the second storage file according to the target number of second values, wherein at least one of the target number of second values indicates a valid state, and the data at positions corresponding to the at least one of the target number of second values indicating the valid state are the second sub-data.

6. The method of claim 2, further comprising:
determining a first index interval having a fragmentation rate exceeding a predetermined threshold in the second storage file according to the second index information; and
compacting data within the second storage file according to the third index information and the first index interval.

7. The method of claim 6, wherein the determining a first index interval having a fragmentation rate exceeding a predetermined threshold in the second storage file according to the second index information comprises:
acquiring a plurality of third values of each second index interval from the second index information;
determining the fragmentation rate of each second index interval according to the plurality of third values; and
determining the second index interval having a fragmentation rate exceeding the predetermined threshold as the first index interval.

8. The method of claim 6, wherein the compacting data within the second storage file according to the third index information and the first index interval comprises:
acquiring a plurality of second values within the first index interval from the third index information;
reading valid data from the second storage file according to the plurality of second values;
compacting the valid data; and
re-storing the compacted valid data into the second storage file and updating the second index information.

9. The method of claim 1, further comprising:
determining a position information of data to be migrated from the first storage file according to the first index information;
reading and deleting the data to be migrated from the first storage file according to the position information of the data to be migrated, and storing the data to be migrated into the second storage file in the storage mode of the second storage file; and
updating the first index information and at least one index information of the second storage file.

10. The method of claim 1, further comprising:
in response to receiving a data storage request, determining a data length of data to be stored according to the data storage request;
storing the data to be stored into the second storage file when the data length of the data to be stored is greater than a length threshold; and
updating at least one index information of the second storage file.

11. An electronic device, comprising:
at least one processor; and
a memory communicatively connected to the at least one processor, wherein the memory stores instructions executable by the at least one processor, and the instructions are configured to, when executed by the at least one processor, cause the at least one processor to:
in response to receiving a data reading request, determine a first storage file and a second storage file according to an identifier of data to be read in the data reading request, wherein a storage mode of the first storage file is different from that of the second storage file, and a data length of the second storage file is greater than that of the first storage file;
determine an index result according to a position information of the data to be read and a first index information of the first storage file;
read first sub-data from the first storage file when the index result indicates that the first storage file comprises the first sub-data, wherein the data to be read comprises the first sub-data and second sub-data; and
read the second sub-data from the second storage file according to the position information and at least one index information of the second storage file.

12. The electronic device of claim 11, wherein the at least one processor is further configured to:
determine a plurality of first values matching the position information from the first index information, wherein the plurality of first values indicate validity states of data in the first storage file; and
determine the index result according to the plurality of first values.

13. The electronic device of claim 12, wherein the at least one processor is further configured to:
determine a first index result when all of the plurality of first values indicate a valid state, wherein the first index result indicates that the first storage file comprises the data to be read;
determine a second index result when all of the plurality of first values indicate an invalid state, wherein the second index result indicates that the second storage file comprises the data to be read; and
determine a third index result when a portion of the plurality of first values indicate a valid state, wherein the third index result indicates that the first storage file comprises the first sub-data, and the data at positions corresponding to the portion of the plurality of first values indicating the valid state are the first sub-data.

14. The electronic device of claim 11, wherein the at least one processor is further configured to:
determine a starting physical address of third sub-data in the second storage file according to the position information and a second index information of the second storage file, wherein the third sub-data is a portion of the data to be read other than the first sub-data; and
read the second sub-data from the second storage file according to the starting physical address and a third index information of the second storage file, wherein the second sub-data is valid data in the third sub-data.

15. The electronic device of claim 14, wherein the at least one processor is further configured to:
acquire a target number of second values following the starting physical address from the third index information, wherein the target number is determined according to a data length of the third sub-data; and
read the second sub-data from the second storage file according to the target number of second values, wherein at least one of the target number of second values indicates a valid state, and the data at positions corresponding to the at least one of the target number of second values indicating the valid state are the second sub-data.

16. The electronic device of claim 12, wherein the at least one processor is further configured to:
determine a first index interval having a fragmentation rate exceeding a predetermined threshold in the second storage file according to the second index information; and
compact data within the second storage file according to the third index information and the first index interval.

17. The electronic device of claim 16, wherein the at least one processor is further configured to:
acquire a plurality of third values of each second index interval from the second index information;
determine the fragmentation rate of each second index interval according to the plurality of third values; and
determine the second index interval having a fragmentation rate exceeding the predetermined threshold as the first index interval.

18. The electronic device of claim 16, wherein the at least one processor is further configured to:
acquire a plurality of second values within the first index interval from the third index information;
read valid data from the second storage file according to the plurality of second values;
compact the valid data; and
re-store the compacted valid data into the second storage file and update the second index information.

19. The electronic device of claim 11, further comprising:
determine a position information of data to be migrated from the first storage file according to the first index information;
read and delete the data to be migrated from the first storage file according to the position information of the data to be migrated, and store the data to be migrated into the second storage file in the storage mode of the second storage file; and
update the first index information and at least one index information of the second storage file.

20. A non-transitory computer-readable storage medium storing computer instructions, wherein the computer instructions, when executed by a processor, are configured to, when executed by a computer, cause the computer to:
in response to receiving a data reading request, determine a first storage file and a second storage file according to an identifier of data to be read in the data reading request, wherein a storage mode of the first storage file is different from that of the second storage file, and a data length of the second storage file is greater than that of the first storage file;
determine an index result according to a position information of the data to be read and a first index information of the first storage file;
read first sub-data from the first storage file when the index result indicates that the first storage file comprises the first sub-data, wherein the data to be read comprises the first sub-data and second sub-data; and
read the second sub-data from the second storage file according to the position information and at least one index information of the second storage file.
